(19) United States
(12) Patent Application Publication
(10) Pub. No.: US 2008/0305347 A1
(43) Pub. Date: Dec. 11, 2008

(54) Protective coating and a coated substrate obtained therefrom

(76) Inventors: Peter William Uhlianuk, Romeo, MI (US); Daniel Lee Neumann, Ponchatoula, LA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/156,806

(22) Filed: Jun. 5, 2008

Related U.S. Application Data
(60) Provisional application No. 60/933,304, filed on Jun. 6, 2007.

(51) Int. Cl. B32B 27/06; B32B 11/04; B32B 13/12

(52) U.S. Cl. 428/489; 428/511; 428/500

(57) ABSTRACT

A coating composition suitable for protecting a substrate from abrasion. The coating composition comprises chlorosulfonated polyolefin, a monomer mixture and catalyst. The monomer mixture is made from (meth)acrylate monomers. The coating composition also acts as a sound deadener, an anti-slip coating, and an anti-wear coating. It can be applied to a variety of substrates especially on a truck bed as a bedliner.

### CROSS-REFERENCE TO RELATED APPLICATION

This application claims the benefit U.S. Provisional Application Ser. No. 60/933,304 filed on Jun. 6, 2007, which is hereby incorporated by reference in its entirety.

### FIELD OF THE INVENTION

This invention is related to a protective coating composition comprising a chlorosulfonated polyolefin and polymerizable monomers.

### DESCRIPTION OF THE RELATED ART

Protective coatings are an important part of many areas of today's society. They are used extensively to protect metal components of rail cars, large shipping containers, liquid and solid storage containers, and as anti-slip, anti-skid coverings of metal floorings. Protective coatings are also used on concrete and asphalt floorings, in truck beds, and on watercraft. The main purpose of these materials is to protect the underlying surface from abrasion, but they can also dampen vibration and act as sound deadening materials.

Many protective coatings are produced using polyurethanes, polyureas, or polyurethane/ureas. These coatings are very durable and can be spray applied in a variety of conditions. Polyurea coatings generally use specialized impingement mixing sprayers due to their rapid curing. Polyurethanes can be spray applied using impingement mixing sprayers, or they can be applied to a substrate after forming a pot mix. Application may be via spray gun, coating, rolling, or any of the other known application methods.

While polyurethane, polyurea, and polyurethane/urea coatings are widely used, they suffer the shortfall of requiring the use of isocyanate and polyisocyanates as crosslinkers to form the desired cured coating. Isocyanate-containing materials are known to have certain limitations and it would be desired to eliminate the use of isocyanate containing materials. The foregoing invention provides protective coatings that do not require the use of isocyanate containing materials.

### SUMMARY OF THE INVENTION

In one aspect, the present invention is a substrate comprising a surface material coated with a coating composition, the coating composition comprising: (i) a film forming binder composition and (ii) a polymerization catalyst, wherein the film forming binder composition comprises;
a) 1 to 50 percent by weight, based on the total weight of the film forming binder, of chlorosulfonated polyolefin; and
b) 50 to 99 percent by weight, based on the total weight of the film forming binder, of a monomer mixture

wherein said substrate surface material is plastic, composite, concrete, asphalt, or wood, and wherein said monomer mixture comprises, by weight percentage based on the weight of the monomer mixture, in the range of from 10 percent by weight to 99 percent by weight (meth)acrylate monomers and in the range of from 90 percent by weight to 1 percent by weight di-, tri- or higher functional (meth)acrylate monomers.

### DETAILED DESCRIPTION OF THE INVENTION

The features and advantages of the present invention will be more readily understood, by those of ordinary skill in the art, from reading the following detailed description. It is to be appreciated that certain features of the invention, which are, for clarity, described above and below in the context of separate embodiments, can also be provided in combination in a single embodiment. Conversely, various features of the invention that are, for brevity, described in the context of a single embodiment, can also be provided separately or in any sub-combination. In addition, references in the singular can also include the plural (for example, “a” and “an” can refer to one or alternately more than one). It is within the ability of one of ordinary skill to determine the proper context and determine the appropriate form, unless the context specifically states otherwise.

As used herein, the phrase “film forming binder” comprises a chlorosulfonated polyolefin, a monomer mixture, and/or the polymerization products of the monomer mixture. The monomer mixture can include di-, tri-, or higher functional (meth)acrylate monomers in addition to the (meth)acrylate monomers. The monomer mixture may also contain a portion of unsaturated olefinic monomers that are not (meth)acrylate monomers for example, styrene, vinyl acetate and/or limonene. Not included in this definition of film forming binder are any polymerization initiators, pigments, fillers, rheology control agents, or other additives that do not become part of the crosslinked network.

It is well known to those of ordinary skill that the term (meth)acrylate is accepted shorthand notation for a composition that comprises acrylate monomer, methacrylate monomer, or a combination of acrylate and methacrylate monomers.

The use of numerical values in the various ranges specified in this application, unless expressly indicated otherwise, are stated as approximations as though the minimum and maximum values within the stated ranges were both preceded by the word “about.” In this manner, slight variations above and below the stated ranges can be used to achieve substantially the same results as values within the ranges. Also, the disclosure of these ranges is intended as a continuous range including every value between the minimum and maximum values.

A coating composition of the present invention comprises a film forming binder and a polymerization catalyst. The film forming binder comprises or consists essentially of a chlorosulfonated polyolefin and a monomer mixture. The chlorosulfonated polyolefin as used herein means those chlorosulfonated polyolefins or polyolefin copolymers and their partially neutralized salts which contain chlorine in an amount in the range of from 1 to 60 percent by weight and sulfur in an amount in the range of from 0.25 to 10 percent by weight, all weights are based upon the weight of the chlorosulfonated polyolefin. The chlorosulfonated polyolefin can include chlorosulfonated homopolymers of C2 to C18 monoolefins, chlorosulfonated copolymers of ethylene and carbon monoxide, and chlorosulfonated copolymers of ethylene and at least one ethylenically unsaturated monomer. The ethylenically unsaturated comonomer can be chosen from C3 to C10 alpha monoolefins, C1 to C12 alkyl esters of unsaturated C3 to C20 monocarboxylic acids, unsaturated C3 to C20 mono- or dicarboxylic acids, and vinyl esters of saturated C2 to C18 carboxylic acids. Suitable chlorosulfonated polyolefins include, for example: chlorosulfonated polyethylene; chlorosulfonated polypropylene; chlorosulfonated polybutene; chlorosulfonated polyisobutylene; chlorosulfonated polydecene; chlorosulfonated ethylene/vinyl acetate copolymers; chlorosulfonated ethylene/carbon monoxide copolymers; chlorosulfonated ethylene/acrylic acid copolymers; chlorosulfonated ethylene/methacrylic acid copolymers; chlorosulfonated ethylene/methacrylate copolymers; chlorosulfonated ethylene/methyl methacrylate copolymers; chlorosulfonated ethylene/n-butyl acrylate copolymers; chlorosulfonated ethylene/n-butyl methacrylate copolymers; chlorosulfonated ethylene/glycidyl acrylate copolymers; chlorosulfonated ethylene/glycidyl methacrylate copolymers; chlorosulfonated maleic anhydride grafted polypropylene and polyethylene polymers; chlorosulfonated ethylene/propylene copolymers; and chlorosulfonated copolymers of ethylene with propylene, 1-butene, 3-methyl-1-pentene, 1-hexene, 1-octene or a combination thereof.

Partially neutralized chlorosulfonated polyolefin or polyolefin copolymer salts are made by neutralizing a portion of the pendant —SO₂Cl groups on these chlorosulfonated polyolefin or polyolefin copolymer with a base. Typically only about 10 to 90% (as evidenced by FTIR measurements or titration analysis) of the —SO₂Cl groups react with base to form a plurality of —SO₃M groups, so that the chlorosulfonated polyolefins are termed “partially neutralized”. The cation, M, originates with the base employed in the neutralization reaction and may be univalent or multivalent. M is preferably sodium ion. Examples of bases that may be utilized in the neutralization reaction include, but are not limited to ammonium hydroxide, sodium hydroxide, sodium carbonate, potassium hydroxide, lithium hydroxide, magnesium hydroxide, calcium hydroxide, aluminum hydroxide, and amine bases such as alkyl amines and various ethoxylated amines. A combination of inorganic base and amine may be used.

Suitable chlorosulfonated polyolefins have, on average, weight average molecular weights in the range of from 1,000 to 300,000. Preferred chlorosulfonated polyolefins have weight average molecular weights in the range of from 5,000 to 250,000. More preferably, the chlorosulfonated polyolefins have weight average molecular weights in the range of from 10,000 to 200,000. At the time of this disclosure, suitable chlorosulfonated polyolefins are available commercially as HYPALON® and ACSIUM® from DuPont Performance Elastomers, Wilmington, Del.

The film forming binder comprises in the range of from 1 percent to 50 percent chlorosulfonated polyolefin. More preferably, the film forming binder contains in the range of from 10 percent to 40 percent chlorosulfonated polyolefin and most preferably, the film forming binder contains in the range of from 15 percent to 30 percent chlorosulfonated polyolefin. All percentages are by weight and are based on the total weight of the film forming binder.

The film forming binder includes in the range of from 50 percent to 99 percent by weight, based on the weight of the film forming binder, of a monomer mixture. The monomer mixture comprises at least one (meth)acrylate monomer. The term (meth)acrylate can encompass both acrylates and methacrylates. Suitable (meth)acrylate monomers include, for example: alkyl, cycloaliphatic and aromatic esters of (meth)acrylic acid; (meth)acrylonitrile; (meth)acrylic acid; (meth)acrylamide; maleic acid; fumaric acid; itaconic acid; functionalized alkyl(meth)acrylate monomers containing epoxy, hydroxy, silane, siloxane, amino, ester, or urethane groups, or combinations thereof. A portion, up to 50 percent by weight, of the total (meth)acrylate monomer charge, of (meth)acrylic acid ester can be replaced by monomer such as vinyl esters, vinyl ethers, styrenes, or a combination thereof. Preferred (meth)acrylate monomers include: methyl acrylate; methyl methacrylate; 2-ethyl hexyl acrylate; 2-ethyl hexyl methacrylate; butyl acrylate; butyl methacrylate; isobornyl acrylate; isobornyl methacrylate; isodecyl acrylate; isodecyl methacrylate; isotridecyl acrylate; isotridecyl methacrylate; acetoacetoxyethyl acrylate; acetoacetoxyethyl methacrylate; epoxy functional (meth)acrylates such as glycidyl acrylate and glycidyl methacrylate; silane functional (meth)acrylates such as 3-(trimethoxysilyl)propyl acrylate and 3-(trimethoxysilyl)propyl methacrylate; polyester (meth)acrylates such as the TONE® monomers available at the time of this disclosure from Dow Chemical Company, Midland, Mich.

The monomer mixture of the present invention can further comprise at least one di-, tri-, or higher functional (meth)acrylate monomer. A portion (up to about 25 percent by weight) of the at least one di-, tri-, or higher functional (meth)acrylate monomer can be replaced by non-(meth)acrylate monomers that have at least two olefinically unsaturated groups that are capable of free radical polymerization.

Examples of such di-, tri- or higher (meth)acrylate monomers include: ethylene glycol di(meth)acrylate; diethyleneglycol di(meth)acrylate; triethyleneglycol di(meth)acrylate; tetraethylene glycol di(meth)acrylate; polyethylene glycol di(meth)acrylate; isomers of propanediol di(meth)acrylates; isomers of butanediol di(meth)acrylates; isomers of hexanediol di(meth)acrylate; di(meth)acrylates; 2,2-dimethylpropanediol di(meth)acrylate; tripropylene glycol di(meth)acrylate; 1,3-butylene glycol di(meth)acrylate; polyalkylene glycol di(meth)acrylates; cyclohexane dimethanol di(meth)acrylate; trimethylolpropane tri(meth)acrylate; polyalkylene glycol tri(meth)acrylates; pentaerythritol tri(meth)acrylate; pentaerythritol tetra(meth)acrylate. Combinations of the (meth)acrylate monomers can also be used. Other useful di(meth)acrylate monomer are isomers of polyalkanediol (meth)acrylates wherein the alkane portion contains in the range of from 2 to 30 carbon atoms. There is essentially no upper limit to the number of carbon atoms in the alkane group however, at greater than 30 carbon atoms the materials tend to be solids which make them less useful in a liquid spray application.

Urethane di-, tri-, or higher (meth)acrylates can also be used, since they can impart increased flexibility to the cured coating layer and reduced brittleness, when used properly in coating applications. They can be produced by any of the methods known to those in the art. Two typical methods are 1) reacting a polyisocyanate with a hydroxy-containing (meth)acrylate, such as 2-hydroxyethyl(meth)acrylate; and 2) reacting an isocyanato(meth)acrylate with a suitable polyol.

Suitable non-(meth)acrylate monomers that have at least two olefinically unsaturated groups that are capable of free radical polymerization include, for example: limonene; linoleic and linolenic acids and ester derivatives and ortho-, meta-, and para-isomers of N,N-phenylenedimaleimide.

The monomer mixture contains in the range of from 10 percent to 99 percent by weight of at least one (meth)acrylate monomer and in the range of from 90 percent to 1 percent by weight of the at least one di-, tri- or higher functional (meth)acrylate monomer. Preferably, the monomer mixture comprises in the range of from 15 percent to 85 percent by weight of at least one (meth)acrylate monomer and in the range of from 85 percent to 15 percent by weight of the at least one di-, tri- or higher functional (meth)acrylate monomer. Most preferably, the monomer mixture comprises in the range of from 20 percent to 80 percent by weight of at least one (meth)acrylate monomer and in the range of from 80 percent to 20 percent by weight of the at least one di-, tri-, or higher functional (meth)acrylate monomer. All weight percentages are based on the total weight of the monomer mixture.

To obtain the film forming binder, the chlorosulfonated polyolefin can be dissolved in the monomer mixture to form a solution or the chlorosulfonated polyolefin can be suspended in the monomer mixture. Preferably, the chlorosulfonated polyolefin forms a solution in the monomer mixture. The film forming binder is produced by agitating the chlorosulfonated polyolefin and the monomer mixture for a sufficient amount of time to disperse or dissolve the chlorosulfonated polyolefin in the monomer mixture. Optionally, the mixture can be heated to obtain the desired solution or suspension. If the mixture is heated, care should be taken so that the monomer mixture does not thermally polymerize, that is by ensuring the absence of thermal catalysts and/or by regulating the temperature of the mixture, for example. Preferably, the mixture remains in solution without the formation of precipitates or phase separation upon removal of the agitation. More preferably, the composition remains in solution without the formation of precipitates or phase separation for at least one month.

The coating composition further includes polymerization catalysts. Suitable polymerization catalysts can be any catalyst or combination of catalysts useful for generating free radicals, such as, for example: peroxides; peracids; peresters; and azo catalysts. Also suitable are organometallic accelerators and amine based activators such as tertiary amines. The following concentrations of polymerization catalyst, as weight percent of the solution of the film forming binder, have been found to be suitable for use in the practice of the present invention: in the range of from 0.05 percent to 10 percent for peroxides, peracids, peresters and azo catalysts; and in the range of from 0.1 percent to 5 percent for amine based activators. Organometallic accelerators can be present in the range of from 0.001 percent by weight up to about 5 percent by weight, based upon the weight of the film forming binder.

Suitable peroxides, peracids, and peresters can be selected from, for example, hydrogen peroxide; m-chloroperoxy benzoic acid; t-butyl peroxyacetate; t-butyl peroxybenzoate; t-butyl peroxyoctoate; t-butyl peroxyneodecanoate; t-butylperoxy isobutyrate; t-amyl peroxypivalate; t-butyl peroxypivalate; di-isopropyl peroxydicarbonate; dicyclohexyl peroxydicarbonate; dicumyl peroxide; dibenzoyl peroxide; dilauroyl peroxide; potassium peroxydisulfate; ammonium peroxydisulfate; cumene hydrogen peroxide, t-butyl peroxide, di t-butyl peroxide, t-amyl peroxyacetate or any combination thereof.

Suitable azo catalysts can be selected from, for example, ammonium persulfate; azocumene; 2,2′-azobis(isobutyronitrile) (Vazo® 64 thermal initiator supplied by Du Pont Company, Wilmington, Del.); 4,4′-azobis(4-cyanovaleric acid) (Vazo® 52 thermal initiator supplied by Du Pont Company, Wilmington, Del.) and 2-(t-butylazo)-2-cyanopropane, 2,2′-azobis(2-methylbutanenitrile); dimethyl 2,2′-azobis(methyl isobutyrate); 4,4′-azobis(4-cyanopentanoic acid); 4,4′-azobis(4-cyanopentan-1-ol); 1,1′-azobis(cyclohexanecarbonitrile); 2-(t-butylazo)-2-cyanopropane; 2,2′-azobis[2-methyl-N-(1,1)-bis(hydroxymethyl)-2-hydroxyethyl]propionamide; 2,2′-azobis[2-methyl-N-hydroxyethyl)]-propionamide; 2,2′-azobis(N,N′-dimethyleneisobutyramidine) dihydrochloride; 2,2′-azobis(2-amidinopropane) dihydrochloride; 2,2′-azobis(N,N′-dimethyleneisobutyramine); 2,2′-azobis(2-methyl-N-[1,1-bis(hydroxymethyl)-2-hydroxyethyl]propionamide); 2,2′-azobis(2-methyl-N-[1,1-bis(hydroxymethyl)ethyl]propionamide); 2,2′-azobis[2-methyl-N-(2-hydroxyethyl)propionamide]; 2,2′-azobis(isobutyramide) dihydrate, 2,2′-azobis(2,2,4-trimethylpentane); 2,2′-azobis(2-methylpropane); or any combination thereof.

Suitable amine-based activators include, for example, N,N-dimethylaniline; N,N-diethylaniline; N,N-dimethylaniline; N,N-diethylaniline; N,N-diisopropyl-p-toluidine; substituted 1,2-dihydropyridines; guanidine; or a combination thereof.

Organometallic accelerators, such as the organic acid salt of a transition metal, for example, copper, cobalt, nickel, manganese or iron naphthenate, octoate, hexanoate, and/or propionate can optionally be added. The organometallic accelerators can be present in the range from 0.001 percent by weight up to about 5 percent by weight, based upon the weight of the film forming binder.

The coating composition can also include pigments. Typical pigments that can be used in the composition are well known to one of ordinary skill in the coating art. Suitable pigments include, for example: talc; china clay; barites; carbonates; silicates; and color pigment such as metallic oxides such as titanium dioxide; zinc oxide; iron oxide; carbon black; and organic colored pigments and dyes.

The coating compositions can optionally further comprise light absorbers and/or light stabilizers. Examples of commercially available UV light absorbers include but are not limited to TINUVIN® 1130, TINUVIN® 171, TINUVIN® 384-2, TINUVIN® 0928, TINUVIN® 328, TINUVIN® 400 and CHIMASSORB® 81 all available from Ciba Specialty Chemicals Corporation of Glen Ellyn, Ill. Examples of commercially available hindered amine light stabilizers include but are limited to TINUVIN® 292, TINUVIN® 123, TINUVIN®144 and TINUVIN® 154, all also available from Ciba Corporation.

The coating composition of the present invention can also contain conventional additives, such as but not limited to, stabilizers, rheology control agents, flow agents, and toughening agents. Typically useful conventional formulation additives include leveling and flow control agents, for example, Resiflow®S (polybutylacrylate), BYK® 320 or 325 (silicone leveling agents, supplied by BYK Chemie, Wallingford, Conn.), BYK® 347 (polyether-modified siloxane, supplied by BYK Chemie, Wallingford, Conn.) and rheology control agents, such as, fumed silica.

The coating compositions can optionally include up to 10 percent by weight, based upon the total weight of the coating composition, of fillers. Suitable fillers include, for example, stone powder, glass fibers or spheres, carbon fibers, mica, lithopone, zinc oxide, zirconium silicate, iron oxides, diatomaceous earth, calcium carbonate, magnesium oxide, chromic oxide, zirconium oxide, aluminum oxide, crushed quartz, calcined clay, talc, kaolin, asbestos, cellulose, wood flour, cork, cotton and synthetic textile fibers, especially reinforcing fillers such as glass fibers and carbon fibers, polyaramids, especially KEVLAR® polyaramid floc, fiber, staple and pulp (available from DuPont, Wilmington, Del., KEVLAR® is poly(p-phenylene terephthalamide), as well as colorants such as metal flakes, glass flakes and beads, ceramic particles, polymer particles or a combination thereof. Any of the forms of KEVLAR® polyaramid are preferred.

Many substrates can be coated with the coating composition to form a protective coating thereon. The coating composition can be applied to metal, plastic, composites, concrete, asphalt, or wood. In one embodiment, the composition is applied to a metal surface, wherein the metal surface is either uncoated or it can be previously coated. If the substrate is coated, the previous coating can comprise any conventional coating known or useful for coating metal surfaces, including electrocoats, primers, basecoats, clear coats, and/or other corrosion protection coatings, for example. In a preferred embodiment, the coating composition is applied to surfaces of automotive vehicles and can be applied in addition to or as a replacement for a clear coat.

Depending upon the desired texture of the coating, the composition can be applied to achieve a smooth surface or a roughened or even a coarse surface over all or part of the surface. When the composition is used to form a truck bedliner, the coating can be applied to one or more of the floor, sidewalls head board, tailgate or other component of a pickup truck bed cargo area.

In certain embodiments, the coated or uncoated surface of a substrate can be sanded, scuffed, primed, or otherwise treated prior to application of the composition to the substrate. For example, it can be desirable to apply a suitable adhesion promoter or primer to the surface to be coated. An example of one such primer is available commercially from DuPont, Wilmington, Del. under the code 864-DG-007. Such pretreatment techniques can assist the coating formed on the substrate to tenaciously adhere to the surface of the substrate. In another example, the substrate is pretreated with plasma, for example, ionizing oxygen molecules that are directed toward the surface of the substrate. In this manner, the plasma treatment forms suitable groups that bond with the composition such that the composition forms a coating that is even more tenaciously adhered to the surface of the substrate. Other surface treatments can be employed as desired.

The coating composition can be applied to a substrate by known processes. Non-limiting examples include air-assisted spray, airless spray, plural component spray, brush, roller, squeegee, roll coating, curtain coating, knife coating, and flow coating. Preferably, the coating composition is applied via a plural component spray gun.

The coating composition is preferably applied as a two-component composition using a plural component spray gun. The first component comprises the solution or suspension of the chlorosulfonated polyolefin in the monomer mixture. The second component comprises the catalyst. The catalyst can be in a dissolved in any one or more of the monomers in the monomer mixture, it can be dissolved in a suitable liquid carrier, or it can be dissolved in a combination of a liquid carrier and monomers. Monomers, pigments, fillers, or other optional additives can be added to either component. When using plural component spray gun to apply the coating composition to the substrate, the two components are metered from supply containers and can be mixed prior to entering the spray gun, they can be mixed in the spray gun, or they can be mixed after leaving the spray gun as in an impingement spray gun. The applied coating composition then cures to form the protective coating.

In another embodiment of the invention, the solution of chlorosulfonated polyolefin in the monomer mixture is combined with the catalyst mixture to form a pot mix. Prior to complete curing of the pot mixture, the pot mix can be applied to the substrate via known methods, such as brushing, roller coating, knife coating and/or flow coating. The pot mix can be formulated to have a pot life that is any time period within the range of from 1 minute to several hours, wherein the pot mixture is not substantially cured and may be applied to the substrate in a substantially uncured state at any time within the given pot life.

After the coating composition is applied to the substrate, the applied composition is cured. Curing preferably takes place at ambient conditions, i.e., in the range of from 10° C. to 50° C. and from 10 percent to 90 percent relative humidity. Optionally, an ultraviolet or infrared light source or other heat source can be used to help accelerate the curing of the coating composition.

The coating composition is applied in a single pass or it can be applied in multiple coats and is applied at such a rate to achieve a dry film thickness of about 30 micrometers or greater. The minimum dry film thickness is about 30 micrometers. There is no particular upper limit to the thickness. The coating composition can be applied in thickness greater than 2.5 centimeters. However, for the purposes of using the coating composition as a protective coating, a practical upper limit for the dry film thickness will be assumed to be about 1.3 centimeters.

The coating compositions are particularly suited for use as protective coatings, anti-slip coatings, anti-wear coatings, anti-abrasion coatings for truck beds, vehicle/trailer floors, and/or waterproofing coatings for truck beds, rail car containers, shipping containers, floors of livestock trailers, boat/personal watercraft trailers, and watercraft. The cured coating composition is suitable for use as a waterproof barrier in storage containers, especially in containers holding aqueous based materials. The cured coating composition protects the underlying surface from damage; it dampens the vibration of the coated substrate; is a waterproof barrier; and acts as both a sound deadener and anti-slip/anti-skid coating.

In one embodiment, the coating composition can be applied to the bed of a truck to form a truck bedliner. Preferably, the metal substrate has been treated with at least a rust preventative phosphate layer. More preferably, the truck bed has at least one of an electrocoat layer, a primer layer, a basecoat layer, or a clearcoat layer prior to coating with the coating composition of the invention.

### EXAMPLES

The information provided regarding the source of availability of materials used herein is accurate as of the time of this disclosure. Unless otherwise specified, all chemicals are available from the Aldrich Chemical Company, Milwaukee, Wis.

HYPALON® 20 and HYPALON® 30 chlorosulfonated polyethylenes are each available from DuPont Performance Elastomers, Wilmington.

Isotridecyl acrylate and cyclohexane dimethanol dimethacrylate are both available from Sartomer Corporation Exton, Pa.

TONE M100® is available from the Dow Chemical Company, Midland, Mich.

Dibutyl tin dilaurate is available neat from Air Products and Chemicals, INC., Allentown, Pa.

d-Limonene is available from Florida Chemical Company, Winter Haven, Fla.

RAVEN® 500, from Columbian Chemicals Company, Marietta, Ga.

VANAX 808HP® amine catalyst is available from the R. T. Vanderbilt Company, Norwalk, Conn.

Copper naphthenate is available from Merichem Chemicals, Tuscaloosa, Ala.

Tack free time was determined by touching the coated panel with a wooden tongue depressor. The tack free time was noted when the tongue depressor pressed to the surface with moderate pressure shows no sign of wet coating composition on it.

The adhesion of a sample was tested using an Instron machine pulling a 1-inch wide sample adhered to a substrate at a 90-degree angle.

The moisture resistance of a sample was tested measuring the sample weight gain after submersion of a sample in distilled water for 60 days at room temperature. No effect means that the sample did not gain weight.

Unless otherwise noted, all amounts are in parts by weight.

TABLE 1
PART A

| | | Exam- | Exam- | Exam- |
|---|---|---|---|---|
| Ingredient | | ple 1 | ple 2 | ple 3 |
| Portion 1 | HYPALON 20 ® | 400 | 400 | 400 |
| | Isodecyl acrylate | 264 | 0 | 264 |
| | Isotridecyl acrylate | 0 | 264 | 0 |
| | Methyl methacrylate | 200 | 200 | 0 |
| | 2-Ethylhexyl methacrylate | 464 | 464 | 464 |
| | BHT | 3 | 3 | 3 |
| | 3-(trimethoxysilyl)propyl | 400 | 400 | 400 |
| | methacrylate | | | |
| | 1,6-heaxane diol diacrylate | 60 | 60 | 60 |
| | Glycidyl methacrylate | 0 | 0 | 200 |
| Portion 2 | Cumene Hydroperoxide | 10 | 10 | 10 |

TABLE 2
PART B

| Ingredient | |
|---|---|
| VANAX 808HP ® | 80 |
| TONE M100 ® | 704 |
| Dibutyl tin dilaurate | 16 |

The ingredients of Part A—Portion 1 were added to a plastic bottle and rolled on a roller mill at 20 rpms for 8 hours until the HYPALON® dissolved. Part A—Portion 2 was then added to this mixture and the mixture was stirred with a spatula.

The ingredients of Part B were placed into a separate container and mixed using an air mixer until a solution formed, which required about 5 minutes.

Parts A and B were filtered and then loaded into an air atomized two-component spray gun. The mixing ratio of Part A/Part B was 10/1. The coatings were applied at 120 mils (3.048 mm) onto steel panels that had previously been electrocoated and primed. The panels were allowed to cure at ambient conditions.

TABLE 3

| | Tack | Adhesion - | | |
|---|---|---|---|---|
| | Free Time | Initial | Adhesion - 30 | Moisture |
| Example | Minutes | (lbs/in²) | Day (lbs/in²) | Resistance |
| 1 | 6 | 8 | 24 | No effect |
| 2 | 11 | 17 | 31 | No effect |
| 3 | 4 | 14 | 29 | No effect |

### Example 4

TABLE 4
PART A

| Ingredients | | |
|---|---|---|
| Portion 1 | HYPALON 30 ® | 350 |
| | 2-Ethylhexyl acrylate | 140 |
| | Vinyl Acetate | 70 |
| | Limonene | 70 |
| | Methyl methacrylate | 210 |
| | Cyclohexane dimethanol | 350 |
| | dimethacrylate | |
| | Hexanediol diacrylate | 98 |
| | 3-(trimethoxysilyl)propyl | 112 |
| | methacrylate | |
| | Dibutyl tin dilaurate | 7 |
| | RAVEN ® 500 | 10 |
| Portion 2 | Cumene hydroperoxide | 8.44 |

TABLE 5
PART B

| Ingredient | |
|---|---|
| VANAX 808HP ® | 24.8 |
| Isobornyl acrylate | 194.85 |
| Copper Naphthenate | 6.35 |

The ingredients of Part A—portion 1 were added to a plastic bottle and rolled on a roller mill at 30 rpms for 5 hours until the HYPALON® dissolved. Part A—portion 2 was then added to this mixture and the mixture was stirred with a spatula. The ingredients of Part B were placed into a separate container and mixed using an air mixer until a solution formed, which required about 5 minutes.

Both components were filtered then loaded into an air atomized two-component spray gun. The mixing ratio of Part A/Part B was 6.3/1. The coatings were applied at 100 mils (2.54 mm) to electrocoated and primed steel panels. The panels were allowed to cure at ambient conditions. The tack free time was determined to be 2 minutes. The initial adhesion of the coating was tested by means of an Instron machine. It was found to be 5 lbs/in².

What is claimed is:

1. A substrate comprising a surface material coated with a coating composition, the coating composition comprising: (i) a film forming binder composition and (ii) a polymerization catalyst, wherein the film forming binder composition comprises;
b) 1 to 50 percent by weight, based on the total weight of the film forming binder, of chlorosulfonated polyolefin; and
b) 50 to 99 percent by weight, based on the total weight of the film forming binder, of a monomer mixture
wherein said substrate surface material is plastic, composite, concrete, asphalt, or wood, and wherein said monomer mixture comprises, by weight percentage based on the weight of the monomer mixture, in the range of from 10 percent by weight to 99 percent by weight (meth)acrylate monomers and in the range of from 90 percent by weight to 1 percent by weight di-, tri- or higher functional (meth)acrylate monomers.

2. The substrate of claim 1 wherein said chlorosulfonated polyolefin has a chlorine content in the range of from 1 to 60 percent by weight and a sulfur content in the range of from 0.25 to 10 percent by weight, wherein all percent by weights are based on the weight of said chlorosulfonated polyolefin and said chlorosulfonated polyolefin has an average weight average molecular weight in the range of from 1,000 to 300,000.

3. The substrate of claim 1 wherein the chlorosulfonated polyolefin is dissolved in the monomer mixture.

4. The substrate of claim 1 further comprising rheology control agents, leveling agents, light stabilizers, fillers or a combination thereof.

5. The substrate of claim 4 wherein the filler is poly(p-phenylene terephthalamide) floc, fiber, staple, or pulp.

6. The substrate of claim 1 wherein the polymerization catalyst is chosen from the group consisting of peroxides, azo compounds, amine based activators, organometallic accelerators, and a combination thereof.

7. The substrate of claim 1 wherein the (meth)acrylate monomer is selected from the group consisting of methyl methacrylate, isobornyl acrylate, 2-ethylhexyl acrylate, and a combination thereof.

8. The substrate of claim 1 wherein the di-, tri- or higher functional (meth)acrylate monomer is selected from the group consisting of hexanediol diacrylate, cyclohexane dimethanol dimethacrylate, trimethylolpropane triacrylate, and a combination thereof.
